(19) United States
(12) Patent Application Publication
(10) Pub. No.: US 2024/0256632 A1
(43) Pub. Date: Aug. 1, 2024

(54) NEURAL NETWORK CALCULATION DEVICE AND NUMERICAL CONVERSION METHOD IN NEURAL NETWORK CALCULATION

(71) Applicant: NEUCHIPS CORPORATION, Hsinchu City (TW)

(72) Inventors: Chiung-Liang Lin, Taichung City (TW); Cheng-Bing Wu, Hsinchu City (TW); YuShan Ruan, New Taipei City (TW)

(73) Assignee: NEUCHIPS CORPORATION, Hsinchu City (TW)

(21) Appl. No.: 18/180,134

(22) Filed: Mar. 8, 2023

(30) Foreign Application Priority Data
Jan. 30, 2023 (TW) 112103018

(51) Int. Cl. G06F 17/16

(52) U.S. Cl. CPC G06F 17/16

(57) ABSTRACT

A neural network (NN) calculation device and a numerical conversion method in NN calculation. The NN calculation device includes a memory and a matrix operation circuit. The memory provides a scaled weight matrix. The scaled weight matrix is a scaled result generated by performing pre-scaling on an original weight matrix of a trained NN model. The matrix operation circuit is coupled to the memory. The matrix operation circuit performs a floating-point matrix operation on an activation matrix and the scaled weight matrix to obtain a first operation result matrix, and performs a floating-point-to-integer conversion to convert the first operation result matrix into a second operation result matrix. Alternatively, the matrix operation circuit performs integer-to-floating-point conversion to convert a first activation matrix into a second activation matrix, and performs a floating-point matrix operation on the second activation matrix and a scaled weight matrix to obtain an operation result matrix.

### CROSS-REFERENCE TO RELATED APPLICATION

This application claims the priority benefit of Taiwan application no. 112103018, filed on Jan. 30, 2023. The entirety of the above-mentioned patent application is hereby incorporated by reference herein and made a part of this specification.

### BACKGROUND

### Technical Field

The disclosure relates to a computing device, and in particular to a neural network (NN) calculation device and a numerical conversion method in NN calculation.

### Description of Related Art

Artificial neural network (ANN) is referred to as neural network (NN) for short. Generally, each weight and each bias in a trained NN model may be regarded as constants. Depending on the practical design, the weight and/or the bias may be vectors, matrices, tensors, or other data. In the applications of neural networks, it is typically necessary to perform matrix multiplications and additions in multiple layers. For example, a multilayer perceptron (MLP) has multiple linear operation layers. A weight matrix and an activation matrix are generally used to perform a matrix multiplication operation in each linear operation layer to obtain a multiplication result matrix. A matrix addition operation may further be performed on the multiplication result matrix with a bias matrix to obtain an operation result matrix. The operation result matrix of the current linear operation layer may serve as the input of the next linear operation layer (the activation matrix of the next linear operation layer).

Generally, computing performance of an integer operation is better than that of a floating-point operation, and accuracy of a floating-point operation is better than that of an integer operation. To balance computing performance and accuracy, in neural network operations, integer operations are used in some computations to speed up computations, and floating-point operations are used in some computations to increase accuracy. How to efficiently perform numerical conversion (floating-point-to-integer conversion or integer-to-floating-point conversion) in neural network operations is one of many technical issues in the field of neural networks.

It should be noted that the contents of the section of “Description of Related Art” is used to help understand the disclosure. Some (or all) of the contents disclosed in the section of “Description of Related Art” may not pertain to the conventional technology known to persons with ordinary skills in the art. The contents disclosed in the section of “Description of Related Art” does not mean to have been known to persons with ordinary skills in the art prior to the filing of this application.

### SUMMARY

The disclosure provides a neural network (NN) calculation device and a numerical conversion method in NN calculation to efficiently perform numerical conversion in NN calculation.

In an embodiment of the disclosure, the numerical conversion method includes the following. A floating-point matrix operation is performed on an activation matrix and a scaled weight matrix to obtain a first operation result matrix. The scaled weight matrix is a first scaled result generated by performing first pre-scaling on an original weight matrix of a trained neural network model. Floating-point-to-integer conversion is performed to convert the first operation result matrix into a second operation result matrix.

In an embodiment of the disclosure, the NN calculation device includes a memory and a matrix operation circuit. The memory is configured to store and provide a scaled weight matrix. The scaled weight matrix is a first scaled result generated by performing first pre-scaling on an original weight matrix of a trained neural network model. The matrix operation circuit is coupled to the memory. The matrix operation circuit performs a floating-point matrix operation on an activation matrix and the scaled weight matrix to obtain a first operation result matrix. The matrix operation circuit performs floating-point-to-integer conversion to convert the first operation result matrix into a second operation result matrix.

In an embodiment of the disclosure, the numerical conversion method includes the following. Integer-to-floating-point conversion is performed to convert a first activation matrix into a second activation matrix. A floating-point matrix operation is performed on the second activation matrix and a scaled weight matrix to obtain an operation result matrix. The scaled weight matrix is a scaled result generated by performing pre-scaling on an original weight matrix of a trained neural network model.

In an embodiment of the disclosure, the NN calculation device includes a memory and a matrix operation circuit. The memory is configured to store and provide a scaled weight matrix. The scaled weight matrix is a scaled result generated by performing pre-scaling on an original weight matrix of a trained neural network model. The matrix operation circuit is coupled to the memory. The matrix operation circuit performs integer-to-floating-point conversion to convert a first activation matrix into a second activation matrix. The matrix operation circuit performs a floating-point matrix operation on the second activation matrix and the scaled weight matrix to obtain an operation result matrix.

Based on the foregoing, the matrix operation circuit may obtain the scaled weight matrix from the memory. In some embodiments, the matrix operation circuit may perform a floating-point matrix operation on the activation matrix and the scaled weight matrix to obtain the first operation result matrix (a floating-point matrix), and then convert the floating-point matrix into an integer matrix (the second operation result matrix) for use in subsequent computations. In other embodiments, the matrix operation circuit may convert the integer matrix (the first activation matrix) into a floating-point matrix (the second activation matrix), and then perform a floating-point matrix operation on the second activation matrix and the scaled weight matrix to obtain the operation result matrix. The scaled weight matrix is a scaled result generated by performing pre-scaling on the original weight matrix of the trained NN model. Since scaling has been completed in advance in the weight matrix, it is not necessary to perform scaling during each numerical conversion (floating-point-to-integer conversion or integer-to-floating-point conversion). On this basis, the matrix operation circuit may efficiently perform numerical conversion in NN calculation.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic circuit block diagram of an NN calculation device according to an embodiment of the disclosure.

FIG. 2 is a schematic circuit block diagram of a matrix operation circuit according to an embodiment.

FIG. 3 is a schematic flowchart of a numerical conversion method in NN calculation according to an embodiment.

FIG. 4 is a schematic circuit block diagram of a matrix operation circuit according to an embodiment of the disclosure.

FIG. 5 is a schematic flowchart of NN calculation according to an embodiment of the disclosure.

FIG. 6 is a schematic flowchart of a numerical conversion method in NN calculation according to an embodiment of the disclosure.

FIG. 7 is a schematic circuit block diagram of a matrix operation circuit according to another embodiment.

FIG. 8 is a schematic flowchart of a numerical conversion method in NN calculation according to another embodiment.

FIG. 9 is a schematic circuit block diagram of a matrix operation circuit according to another embodiment of the disclosure.

FIG. 10 is a schematic flowchart of a numerical conversion method in NN calculation according to another embodiment of the disclosure.

### DESCRIPTION OF THE EMBODIMENTS

The term “coupling (or connection)” used throughout this specification (including the claims) may refer to any direct or indirect means of connection. For example, if it is herein described that a first device is coupled (or connected) to a second device, it should be interpreted that the first device may be directly connected to the second device, or the first device may be indirectly connected to the second device through other devices or some connection means. Terms such as “first” and “second” mentioned throughout this specification (including the claims) are used to name elements, or to distinguish between different embodiments or scopes, and are not used to limit the upper or lower bound of the number of elements, nor used to limit the sequence of elements. In addition, wherever possible, elements/members/steps using the same reference numerals in the drawings and embodiments denote the same or similar parts. Cross-reference may be made to relevant descriptions of elements/members/steps using the same reference numerals or using the same terms in different embodiments.

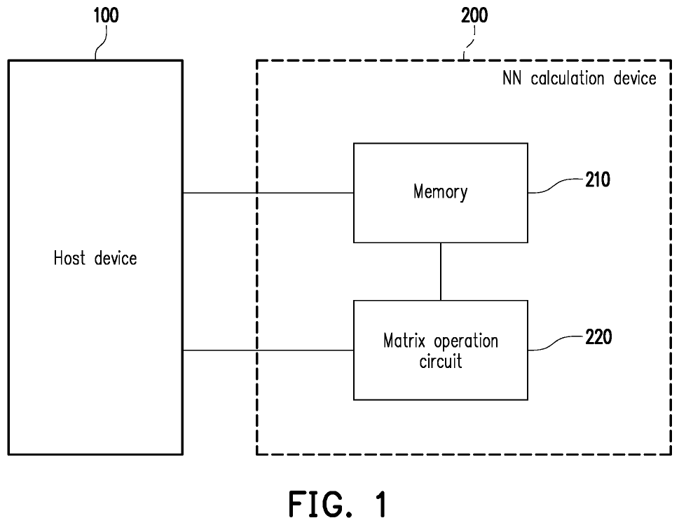

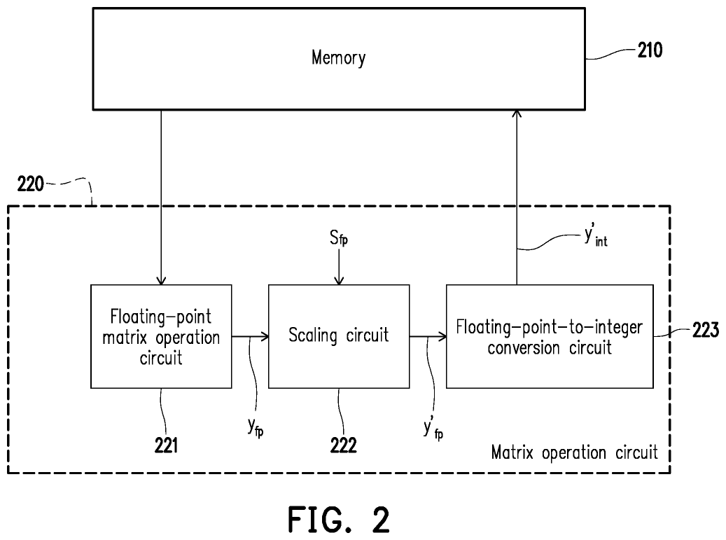

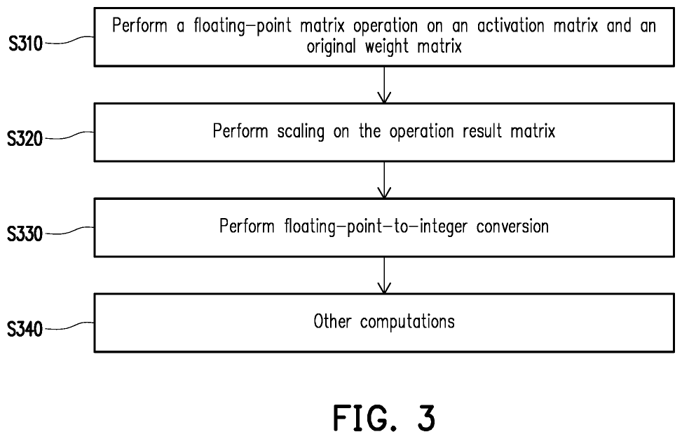

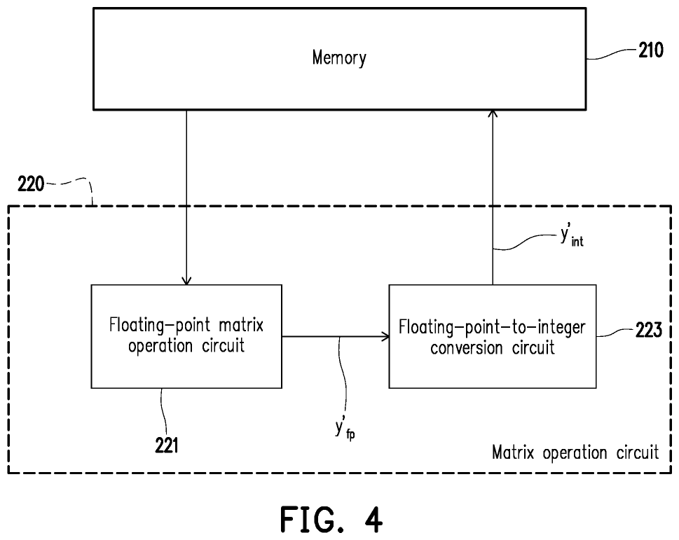

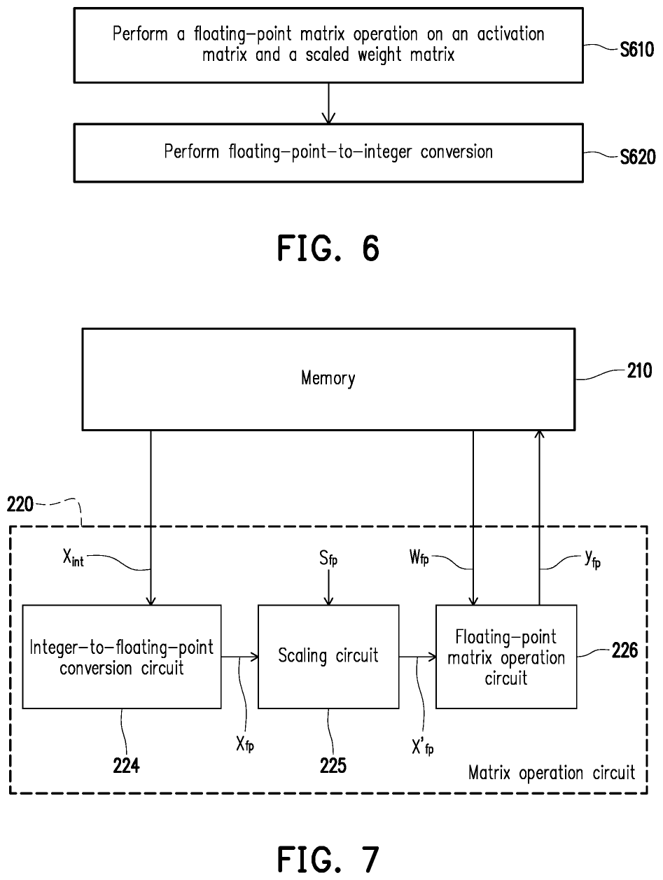

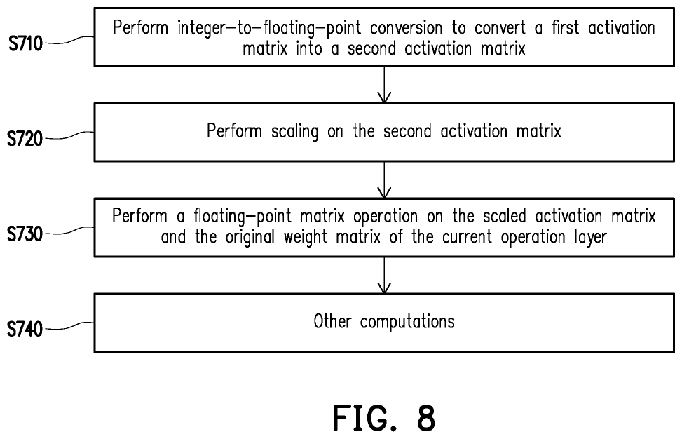

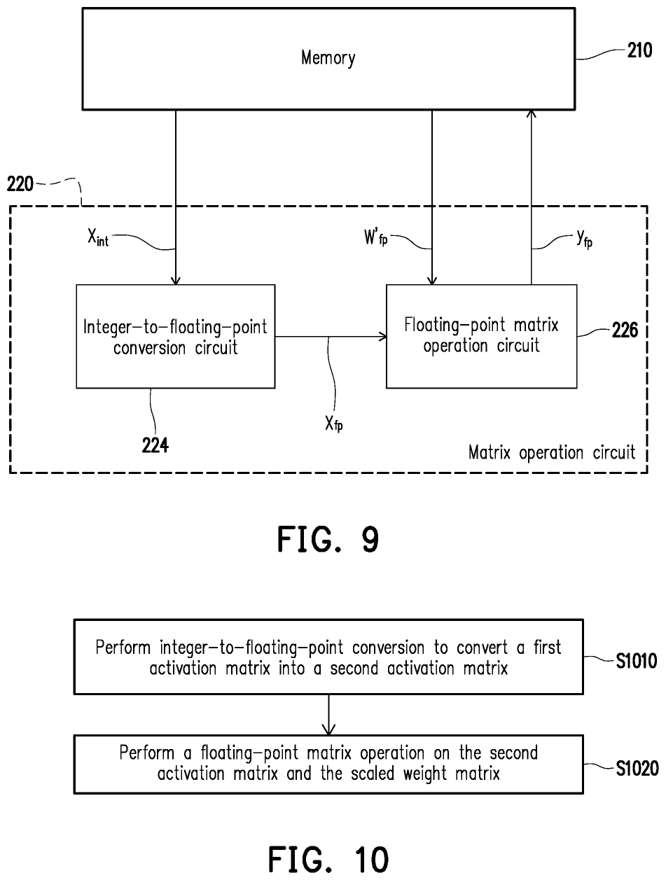

FIG. 1 is a schematic circuit block diagram of an NN calculation device 200 according to an embodiment of the disclosure. In the embodiment shown in FIG. 1, the NN calculation device 200 includes a memory 210 and a matrix operation circuit 220. In the embodiments shown in FIG. 2, FIG. 3. FIG. 7, and FIG. 8 to be described later, a host device 100 may store an original weight matrix and an original bias matrix of a trained NN model in the memory 210 for use by the matrix operation circuit 220. In the embodiments shown in FIG. 4 and FIG. 6 to be described later, the host device 100 may perform pre-scaling on an original weight matrix and an original bias matrix of a trained NN model to generate a sealed weight matrix and a scaled bias matrix. The host device 100 may store the scaled weight matrix and the scaled bias matrix in the memory 210 for use by the matrix operation circuit 220. In the embodiments shown in FIG. 9 and FIG. 10 to be described later, the host device 100 may perform pre-scaling on an original weight matrix of a trained NN model to generate a scaled weight matrix. The host device 100 may store the scaled weight matrix and an original bias matrix in the memory 210 for use by the matrix operation circuit 220.

The matrix operation circuit 220 is coupled to the memory 210. The matrix operation circuit 220 may perform neural network (NN) calculation based on the content of the memory 210. NN calculation generally includes matrix multiplications and additions in multiple layers. For example, a multilayer perceptron (MLP) has multiple linear operation layers. The matrix operation circuit 220 may use a weight matrix and an activation matrix to perform a matrix multiplication operation in each linear operation layer to obtain a multiplication result matrix. The matrix operation circuit 220 may further use the multiplication result matrix and a bias matrix to perform a matrix addition operation to obtain an operation result matrix based on the requirements of a trained NN model. The matrix operation circuit 220 may store the operation result matrix of the current linear operation layer in the memory 210 to serve as the input of the next linear operation layer (the activation matrix of the next linear operation layer).

FIG. 2 is a schematic circuit block diagram of a matrix operation circuit 220 according to an embodiment. In the embodiment shown in FIG. 2, the memory 210 is configured to store and provide an original weight matrix and an original bias matrix of a trained NN model. The matrix operation circuit 220 shown in FIG. 2 includes a floating-point matrix operation circuit 221, a scaling circuit 222, and a floating-point-to-integer conversion circuit 223. The floating-point matrix operation circuit 221 is coupled to the memory 210 to obtain an activation matrix (a floating-point matrix) and the original weight matrix (another floating-point matrix). The floating-point matrix operation circuit 221 performs a floating-point matrix operation on the activation matrix and the original weight matrix of the current operation layer to obtain an operation result matrix y_{fp}. For example, the floating-point matrix operation may include Equation A below. In Equation A, y_{fp} represents an operation result matrix in the form of a floating-point number. W_{fp} represents an original weight matrix in the form of a floating-point number, x_{fp} represents an activation matrix in the form of a floating-point number, and b_{fp} represents an original bias matrix in the form of a floating-point number.

$${y}_{fp} = {W}_{fp} {x}_{fp} + {b}_{fp} \qquad Equation A$$

FIG. 3 is a schematic flowchart of a numerical conversion method in NN calculation according to an embodiment. Based on the practical applications, in some practical operation scenarios, the numerical conversion method shown in FIG. 3 may be performed in one or more of multiple operation layers in NN calculation. With reference to FIG. 2 and FIG. 3, in step S310, the floating-point matrix operation circuit 221 performs a floating-point matrix operation on the activation matrix x_{fp} and the original weight matrix W_{fp} to obtain the operation result matrix yip. The scaling circuit 222 is coupled to the floating-point matrix operation circuit 221 to obtain the operation result matrix y_{fp}. In step S320, the scaling circuit 222 performs scaling on the operation result matrix y_{fp} to obtain a scaled operation result matrix y′_{fp}. For example, in some embodiments, the scaling circuit 222 directly multiplies the operation result matrix y_{fp} by a scaling factor S_{fp} and obtains the scaled operation result matrix y′_{fp}, so as to most effectively quantize an integer matrix during floating-point-to-integer conversion in step S330. In a neural network, the scaling factor S_{fp} for most effectively quantizing the floating-point-to-integer conversion is typically obtained through calibration, which will not be described in detail here. In other embodiments, the scaling circuit 222 may divide the operation result matrix y_{fp} by the scaling factor S_{fp} and obtain the scaled operation result matrix y′_{fp}.

The floating-point-to-integer conversion circuit 223 is coupled to the scaling circuit 222 to obtain the scaled operation result matrix y′_{fp}. In step S330, the floating-point-to-integer conversion circuit 223 performs floating-point-to-integer conversion to convert the scaled operation result matrix y′_{fp} in the form of a floating-point number into an operation result matrix y′ᵢₙₜ (an integer matrix). The floating-point-to-integer conversion circuit 223 stores the operation result matrix y′ᵢₙₜ in the memory 210 for other computations of the current operation layer (step S340). It is necessary to perform scaling (step S320) one time in each operation conversion layer. If the number of floating-point-to-integer conversion layers increases, the amount of time consumed by scaling is increasingly considerable.

FIG. 4 is a schematic circuit block diagram of a matrix operation circuit 220 according to an embodiment of the disclosure. In the embodiment shown in FIG. 4, the memory 210 is configured to store and provide a scaled weight matrix and a scaled bias matrix of a trained NN model. The scaled weight matrix is a scaled result generated by performing pre-scaling on an original weight matrix of the trained NN model, and the scaled bias matrix is a scaled result generated by performing pre-scaling on an original bias matrix of the trained NN model. The matrix operation circuit 220 shown in FIG. 4 includes a floating-point matrix operation circuit 221 and a floating-point-to-integer conversion circuit 223. The floating-point matrix operation circuit 221 is coupled to the memory 210 to obtain an activation matrix (a floating-point matrix) and the scaled weight matrix (another floating-point matrix).

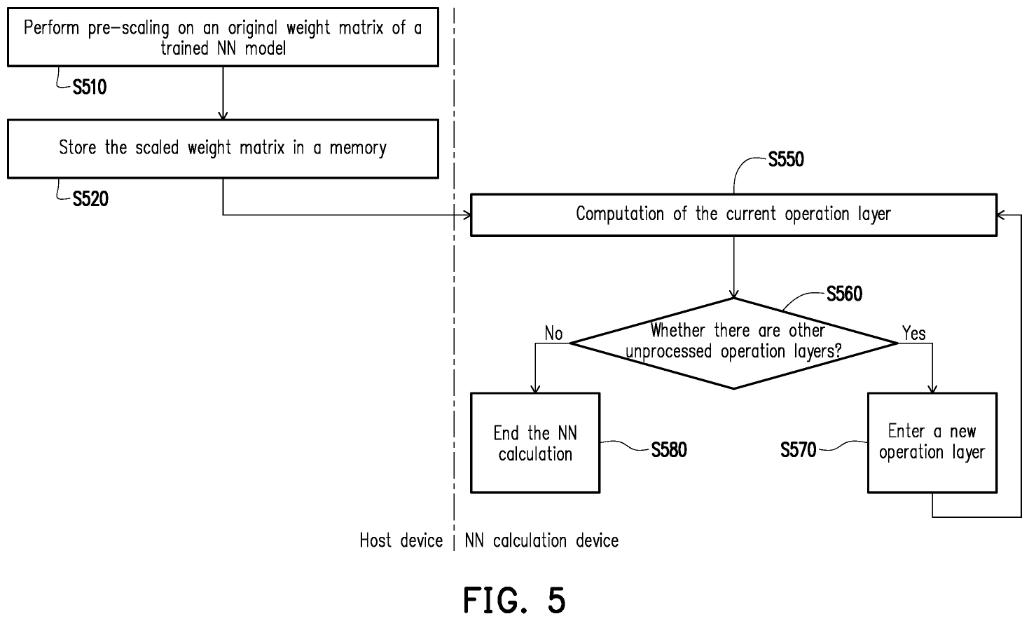

FIG. 5 is a schematic flowchart of NN calculation according to an embodiment of the disclosure. With reference to FIG. 4 and FIG. 5, in step S510, the host device 100 may perform pre-scaling on the original weight matrix used in each operation layer of the trained NN model to generate the scaled weight matrix and/or the scaled bias matrix. A bias matrix may be used to perform a matrix addition operation in one or more operation layers based on the requirements of the trained NN model. The host device 100 may perform pre-scaling on the original bias matrix used in each operation layer of the trained NN model to generate the scaled bias matrix.

For example, the pre-scaling may include the following operations. The host device 100 may multiply a scaling factor S_{fp} by the original weight matrix W_{fp} (W_{fp} represents an original weight matrix in any operation layer) of the trained NN model, and obtain a scaled weight matrix W′_{fp}. Based on the practical design, in some other embodiments, the host device 100 may divide the original weight matrix W_{fp} by the scaling factor S_{fp} to obtain the scaled weight matrix W′_{fp}. Similarly, the host device 100 may multiply the scaling factor S_{fp} by an original bias matrix b_{fp} (b_{fp} represents an original bias matrix in any operation layer) of the trained NN model, and obtain a scaled bias matrix b′_{fp}. Based on the practical design, in some other embodiments, the host device 100 may divide the original bias matrix b_{fp} by the sealing factor S_{fp} and obtain the scaled bias matrix b′_{fp}.

In step S520, the host device 100 may store the scaled weight matrix W′_{fp} (and the scaled bias matrix b′_{fp}) in the memory 210 for use by the matrix operation circuit 220. The host device 100 may perform step S510 and step S520 in advance before NN calculation.

Next, in step S550 to step S580, the matrix operation circuit 220 may perform computations of different operation layers. Generally, computing performance of an integer operation is better than that of a floating-point operation, and accuracy of a floating-point operation is better than that of an integer operation. To balance computing performance and accuracy, based on the practical applications, in the neural network, some operation layers are integer domain operations to speed up computations, and other operation layers are floating-point number domain operations to increase accuracy. As a result, based on the practical operation scenarios, the computation of step S550 may include a floating-point-to-integer conversion operation (e.g., the operation process shown in FIG. 6), or include an integer-to-floating-point conversion operation (e.g., the operation process shown in FIG. 10, to be described in detail later).

After the computation of the current operation layer (step S550) is completed, when there are still other unprocessed operation layers (the determination result of step S560 is “yes”), the matrix operation circuit 220 enters the processing procedures of a new operation layer (step S570), and performs step S550 to step S560 again for the new operation layer. After the computation of the current operation layer (step S550) is completed, when there is no other unprocessed operation layer (the determination result of step S560 is “no”), the NN calculation is ended (step S580).

FIG. 6 is a schematic flowchart of a numerical conversion method in NN calculation according to an embodiment of the disclosure. Based on the practical applications, in some practical operation scenarios, the operations shown in FIG. 6 may be part of multiple operations performed in step S550 shown in FIG. 5. With reference to FIG. 4 and FIG. 6, in step S610, the matrix operation circuit 220 may perform a floating-point matrix operation on an activation matrix x_{fp} and the scaled weight matrix W′_{fp} to obtain an operation result matrix y′_{fp}. For example, the floating-point matrix operation may include a matrix multiplication-addition operation. The matrix multiplication-addition operation includes the following. The matrix operation circuit 220 performs a matrix multiplication operation on the activation matrix x_{fp} and the scaled weight matrix W′_{fp} to obtain a multiplication result matrix; and the matrix operation circuit 220 performs a matrix addition operation on the multiplication result matrix and the scaled bias matrix b′_{fp} to obtain the operation result matrix y′_{fp}. Next, in step S620, the matrix operation circuit 220 may perform floating-point-to-integer conversion to convert the operation result matrix y′_{fp} (a floating-point matrix) into an operation result matrix y′ᵢₙₜ (an integer matrix).

The floating-point matrix operation circuit 221 is coupled to the memory 210 to obtain the activation matrix x_{fp} and the scaled weight matrix W′_{fp}. In step S610, the floating-point matrix operation circuit 221 performs the floating-point matrix operation on the activation matrix x_{fp} and the scaled weight matrix W′_{fp} to obtain the operation result matrix y′_{fp}. For example, the floating-point matrix operation may include Equation B below. In Equation B, y′_{fp} represents an operation result matrix in the form of a floating-point number. W′_{fp} represents a scaled weight matrix in the form of a floating-point number, x_{fp} represents an activation matrix in the form of a floating-point number, and b′_{fp} represents a scaled bias matrix in the form of a floating-point number.

$${y}_{fp}^{′} = {W}_{fp}^{′} {x}_{fp} + {b}_{fp}^{′} \qquad Equation B$$

The floating-point-to-integer conversion circuit 223 shown in FIG. 4 is coupled to the floating-point matrix operation circuit 221 to receive the operation result matrix y′_{fp}. In step S620, the floating-point-to-integer conversion circuit 223 performs floating-point-to-integer conversion to convert the operation result matrix y′_{fp} (a floating-point matrix) into the operation result matrix y′ᵢₙₜ (an integer matrix). The floating-point-to-integer conversion circuit 223 shown in FIG. 4 stores the operation result matrix y′ᵢₙₜ in the memory 210 for other computations of the current operation layer. After the current operation layer is completed, when there are still other unprocessed operation layers, the matrix operation circuit 220 enters the processing procedures of a new operation layer. Compared with steps S310 to S330 shown in FIG. 3, it can be known that it is not necessary to perform scaling in the current operation layer in the embodiment shown in FIG. 6 (i.e., step S320 shown in FIG. 3 may be omitted).

In summary of the above, the matrix operation circuit 220 may obtain the scaled weight matrix W′_{fp} from the memory 210. The scaled weight matrix W′_{fp} is a scaled result generated by performing pre-scaling on the original weight matrix W_{fp} of the trained NN model. In some embodiments, the matrix operation circuit 220 may perform the floating-point matrix operation on the activation matrix x_{fp} and the scaled weight matrix W′_{fp} to obtain the operation result matrix y′_{fp} (a floating-point matrix), and then convert the operation result matrix y′_{fp} into the operation result matrix y′ᵢₙₜ (an integer matrix) for use in subsequent computations. Since scaling has been completed in advance in the weight matrix W′_{fp}, it is not necessary to perform scaling during each numerical conversion (floating-point-to-integer conversion or integer-to-floating-point conversion) in NN calculation. On this basis, the matrix operation circuit 220 may efficiently perform numerical conversion in NN calculation.

FIG. 7 is a schematic circuit block diagram of a matrix operation circuit 220 according to another embodiment. In the embodiment shown in FIG. 7, the memory 210 is configured to store and provide an original weight matrix W_{fp} and an original bias matrix b_{fp} of a trained NN model. The matrix operation circuit 220 shown in FIG. 7 includes an integer-to-floating-point conversion circuit 224, a scaling circuit 225, and a floating-point matrix operation circuit 226. The integer-to-floating-point conversion circuit 224 is coupled to the memory 210 to obtain an activation matrix xᵢₙₜ (an integer matrix). The integer-to-floating-point conversion circuit 224 performs integer-to-floating-point conversion to convert the activation matrix xᵢₙₜ into an activation matrix x_{fp} (a floating-point number matrix).

FIG. 8 is a schematic flowchart of a numerical conversion method in NN calculation according to another embodiment. Based on the practical applications, in some practical operation scenarios, the numerical conversion method shown in FIG. 8 may be performed in one or more of multiple operation layers in NN calculation. With reference to FIG. 7 and FIG. 8, in step S710, the integer-to-floating-point conversion circuit 224 performs integer-to-floating-point conversion to convert the activation matrix xᵢₙₜ (a first activation matrix) into the activation matrix x_{fp} (a second activation matrix). The scaling circuit 225 is coupled to the integer-to-floating-point conversion circuit 224 to obtain the activation matrix x_{fp}. In step S720, the scaling circuit 225 performs scaling on the activation matrix x_{fp} to obtain a scaled activation matrix x′_{fp}. For example, in some embodiments, the scaling circuit 225 may divide the activation matrix x_{fp} by a scaling factor S_{fp} and obtain the scaled activation matrix x′_{fp}. In other embodiments, the scaling circuit 225 multiplies the activation matrix x_{fp} by the scaling factor S_{fp} and obtains the scaled activation matrix x′_{fp}.

The floating-point matrix operation circuit 226 is coupled to the memory 210 to obtain the original weight matrix W_{fp}. The floating-point matrix operation circuit 226 is coupled to the scaling circuit 225 to receive the scaled activation matrix x′_{fp}. In step S730, the floating-point matrix operation circuit 226 performs a floating-point matrix operation on the scaled activation matrix x′_{fp} and the original weight matrix W_{fp} of the current operation layer to obtain an operation result matrix y_{fp}. For example, the floating-point matrix operation may include Equation C below. In Equation C, y_{fp} represents an operation result matrix in the form of a floating-point number, W_{fp} represents an original weight matrix in the form of a floating-point number, x′_{fp} represents a scaled activation matrix in the form of a floating-point number, and b_{fp} represents an original bias matrix in the form of a floating-point number.

$${y}_{fp} = {W}_{fp} {x}_{fp}^{′} + {b}_{fp} \qquad Equation C$$

The floating-point matrix operation circuit 226 stores the operation result matrix y_{fp} in the memory 210 for other computations of the current operation layer (step S740). It is necessary to perform scaling (step S720) one time in each conversion operation layer. If the number of integer-to-floating-point operation layers increases, the amount of time consumed by scaling is increasingly considerable.

FIG. 9 is a schematic circuit block diagram of a matrix operation circuit 220 according to another embodiment of the disclosure. In the embodiment shown in FIG. 9, the memory 210 is configured to store and provide a scaled weight matrix W′_{fp} (W′_{fp} represents a scaled weight matrix in any operation layer) and an original bias matrix b_{fp} of a trained NN model. The scaled weight matrix W′_{fp} is a scaled result generated by performing pre-scaling on an original weight matrix W_{fp} of the trained NN model. The matrix operation circuit 220 shown in FIG. 9 includes an integer-to-floating-point conversion circuit 224 and a floating-point matrix operation circuit 226. The integer-to-floating-point conversion circuit 224 is coupled to the memory 210 to obtain an activation matrix xᵢₙₜ (an integer matrix).

FIG. 10 is a schematic flowchart of a numerical conversion method in NN calculation according to another embodiment of the disclosure. Based on the practical applications, in some practical operation scenarios, the operation shown in FIG. 10 may be part of multiple operations performed in step S550 shown in FIG. 5. In step S510 shown in FIG. 5, the host device 100 may perform pre-scaling on the original weight matrix W_{fp} used in each operation layer of the trained NN model to generate the scaled weight matrix W′_{fp}. For example, the pre-scaling may include the following operations. The host device 100 may divide the original weight matrix W_{fp} (W_{fp} represents an original weight matrix in any operation layer) by a scaling factor S_{fp} to obtain the scaled weight matrix W′_{fp}. Based on the practical design, in some other embodiments, the host device 100 may multiply the scaling factor S_{fp} by the original weight matrix W_{fp} of the trained NN model and obtain the scaled weight matrix W′_{fp}. In step S520 shown in FIG. 5, the host device 100 may store the scaled weight matrix W′_{fp} (and the original bias matrix b_{fp}) in the memory 210 for use by the matrix operation circuit 220.

With reference to FIG. 9 and FIG. 10. In step S1010, the matrix operation circuit 220 may perform integer-to-floating-point conversion to convert the activation matrix xᵢₙₜ (a first activation matrix) into an activation matrix x_{fp} (a second activation matrix). Next, in step S1020, the matrix operation circuit 220 may perform a floating-point matrix operation on the activation matrix x_{fp} and the scaled weight matrix W′_{fp} to obtain an operation result matrix y_{fp}. For example, the floating-point matrix operation may include a matrix multiplication-addition operation. The matrix multiplication-addition operation includes the following. The matrix operation circuit 220 performs a matrix multiplication operation on an activation matrix x_{fp} and the scaled weight matrix W′_{fp} to obtain a multiplication result matrix; and the matrix operation circuit 220 performs a matrix addition operation on the multiplication result matrix and the original bias matrix b_{fp} to obtain the operation result matrix y_{fp}.

The integer-to-floating-point conversion circuit 224 is coupled to the memory 210 to obtain the activation matrix xᵢₙₜ (the first activation matrix). In step S1010, the integer-to-floating-point conversion circuit 224 performs integer-to-floating-point conversion to convert the activation matrix xᵢₙₜ into the activation matrix x_{fp} (the second activation matrix). The floating-point matrix operation circuit 226 is coupled to the memory 210 to obtain the scaled weight matrix W′_{fp}.

The floating-point matrix operation circuit 226 shown in FIG. 9 is coupled to the integer-to-floating-point conversion circuit 224 to receive the activation matrix x_{fp}. In step S1020, the floating-point matrix operation circuit 226 may perform the floating-point matrix operation on the activation matrix x_{fp} and the scaled weight matrix W′_{fp} to obtain the operation result matrix y_{fp}. For example, the floating-point matrix operation may include Equation D below. In Equation D, y_{fp} represents an operation result matrix in the form of a floating-point number, W′_{fp} represents a scaled weight matrix in the form of a floating-point number, x_{fp} represents an activation matrix in the form of a floating-point number, and bop represents a bias matrix in the form of a floating-point number.

$${y}_{fp} = {W}_{fp}^{′} {x}_{fp} + {b}_{fp} \qquad Equation D$$

The floating-point matrix operation circuit 226 stores the operation result matrix y_{fp} in the memory 210 for other computations of the current operation layer. After the current operation layer is completed, when there are still other unprocessed operation layers, the matrix operation circuit 220 enters the processing procedures of a new operation layer. Compared with steps S710 to S730 shown in FIG. 8, it can be known that it is not necessary to perform scaling in the current operation layer in the embodiment shown in FIG. 10 (i.e., step S720 shown in FIG. 8 may be omitted).

In summary of the above, the matrix operation circuit 220 may obtain the scaled weight matrix W′_{fp} from the memory 210. The scaled weight matrix W′_{fp} is a scaled result generated by performing pre-scaling on the original weight matrix W_{fp} of the trained NN model. The matrix operation circuit 220 may convert the activation matrix xᵢₙₜ (an integer matrix) into the activation matrix x_{fp} (a floating-point matrix), and then perform the floating-point matrix operation on the activation matrix x_{fp} and the scaled weight matrix W′_{fp} to obtain the operation result matrix y_{fp}. Since scaling has been completed in advance in the weight matrix W′_{fp}, it is not necessary to perform scaling during each numerical conversion (floating-point-to-integer conversion or integer-to-floating-point conversion) in NN calculation. On this basis, the matrix operation circuit 220 may efficiently perform numerical conversion in NN calculation.

According to different designs, in some embodiments, the matrix operation circuit 220, the floating-point matrix operation circuit 221, the floating-point-to-integer conversion circuit 223, the integer-to-floating-point conversion circuit 224, and (or) the floating-point matrix operation circuit 226 may be realized as a hardware circuit. In other embodiments, the matrix operation circuit 220, the floating-point matrix operation circuit 221, the floating-point-to-integer conversion circuit 223, the integer-to-floating-point conversion circuit 224, and (or) the floating-point matrix operation circuit 226 may be realized as firmware, software (i.e., programs), or a combination of thereof. In still others embodiments, the matrix operation circuit 220, the floating-point matrix operation circuit 221, the floating-point-to-integer conversion circuit 223, the integer-to-floating-point conversion circuit 224, and (or) the floating-point matrix operation circuit 226 may be realized as a combination of multiple ones of hardware, firmware, and software.

In terms of hardware form, the matrix operation circuit 220, the floating-point matrix operation circuit 221, the floating-point-to-integer conversion circuit 223, the integer-to-floating-point conversion circuit 224, and (or) the floating-point matrix operation circuit 226 may be as a logic circuit on an integrated circuit. For example, the relevant functions of the matrix operation circuit 220, the floating-point matrix operation circuit 221, the floating-point-to-integer conversion circuit 223, the integer-to-floating-point conversion circuit 224, and (or) the floating-point matrix operation circuit 226 may be realized as various logic blocks, modules, and circuits in one or more controllers, microcontrollers, microprocessors, application-specific integrated circuits (ASICs), digital signal processors (DSPs), field programmable gate arrays (FPGAs), and/or other processing units. The relevant functions of the matrix operation circuit 220, the floating-point matrix operation circuit 221, the floating-point-to-integer conversion circuit 223, the integer-to-floating-point conversion circuit 224, and (or) the floating-point matrix operation circuit 226 may be realized as a hardware circuit, such as various logic blocks, modules, and circuits in an integrated circuit, by utilizing hardware description languages (e.g., Verilog HDL or VHDL) or other suitable programming languages.

In terms of software form and/or firmware form, the relevant functions of the matrix operation circuit 220, the floating-point matrix operation circuit 221, the floating-point-to-integer conversion circuit 223, the integer-to-floating-point conversion circuit 224, and (or) the floating-point matrix operation circuit 226 may be realized as programming codes. For example, the matrix operation circuit 220, the floating-point matrix operation circuit 221, the floating-point-to-integer conversion circuit 223, the integer-to-floating-point conversion circuit 224, and (or) the floating-point matrix operation circuit 226 are realized by utilizing general programming languages (e.g., C. C++, or assembly language) or other suitable programming languages. The programming codes may be recorded/stored in a “non-transitory computer readable medium”. In some embodiments, the non-transitory computer readable medium includes, for example, a semiconductor memory and (or) a storage device. The semiconductor memory includes a memory card, read only memory (ROM), flash memory, a programmable logic circuit, or other semiconductor memory. The storage device includes a tape, a disk, a hard disk drive (HDD), a solid-state drive (SSD), or other storage devices. Electronic equipment (e.g., a computer, a central processing unit (CPU), a controller, a microcontroller, or a microprocessor) may read and execute the programming codes from the non-transitory computer readable medium, so as to realize the relevant functions of the matrix operation circuit 220, the floating-point matrix operation circuit 221, the floating-point-to-integer conversion circuit 223, the integer-to-floating-point conversion circuit 224, and (or) the floating-point matrix operation circuit 226. Alternatively, the programming codes may be provided to the electronic equipment via any transmission medium (e.g., a communication network or a radio wave). The communication network is, for example, the Internet, a wired communication network, a wireless communication network, or other communication media.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A numerical conversion method in neural network calculation, the method comprising:
performing a floating-point matrix operation on an activation matrix and a scaled weight matrix to obtain a first operation result matrix, wherein the scaled weight matrix is a first scaled result generated by performing first pre-scaling on an original weight matrix of a trained neural network model; and
performing floating-point-to-integer conversion to convert the first operation result matrix into a second operation result matrix.

2. The numerical conversion method according to claim 1, wherein the first pre-scaling comprises:
multiplying the original weight matrix by a scaling factor to obtain the scaled weight matrix; or
dividing the original weight matrix by the scaling factor to obtain the scaled weight matrix.

3. The numerical conversion method according to claim 1, wherein the floating-point matrix operation comprises a matrix multiplication-addition operation, and the matrix multiplication-addition operation comprises:
performing a matrix multiplication operation on the activation matrix and the scaled weight matrix to obtain a multiplication result matrix; and
performing a matrix addition operation on the multiplication result matrix and a scaled bias matrix to obtain the first operation result matrix, wherein the scaled bias matrix is a second scaled result generated by performing second pre-scaling on an original bias matrix of the trained neural network model.

4. The numerical conversion method according to claim 3, wherein the second pre-scaling comprises:
multiplying the original bias matrix by a scaling factor to obtain the scaled bias matrix; or
dividing the original bias matrix by the scaling factor to obtain the scaled bias matrix.

5. A neural network calculation device comprising:
a memory configured to store and provide a scaled weight matrix, wherein the scaled weight matrix is a first scaled result generated by performing first pre-scaling on an original weight matrix of a trained neural network model; and
a matrix operation circuit coupled to the memory, wherein the matrix operation circuit performs a floating-point matrix operation on an activation matrix and the scaled weight matrix to obtain a first operation result matrix, and the matrix operation circuit performs floating-point-to-integer conversion to convert the first operation result matrix into a second operation result matrix.

6. The neural network calculation device according to claim 5, wherein the first pre-scaling comprises:
multiplying the original weight matrix by a scaling factor to obtain the scaled weight matrix by a host device, or dividing the original weight matrix by the scaling factor to obtain the scaled weight matrix by the host device; and
storing the scaled weight matrix by the host device in the memory for use by the matrix operation circuit.

7. The neural network calculation device according to claim 5, wherein the floating-point matrix operation comprises a matrix multiplication-addition operation, and the matrix multiplication-addition operation comprises:
performing a matrix multiplication operation on the activation matrix and the scaled weight matrix to obtain a multiplication result matrix by the matrix operation circuit; and
performing a matrix addition operation on the multiplication result matrix and a scaled bias matrix to obtain the first operation result matrix by the matrix operation circuit, wherein the scaled bias matrix is a second scaled result generated by performing second pre-scaling on an original bias matrix of the trained neural network model.

8. The neural network calculation device according to claim 7, wherein the second pre-scaling comprises:
multiplying the original bias matrix by a scaling factor to obtain the scaled bias matrix by a host device, or dividing the original bias matrix by the scaling factor to obtain the scaled bias matrix by the host device; and
storing the scaled weight matrix by the host device in the memory for use by the matrix operation circuit.

9. The neural network calculation device according to claim 5, wherein the matrix operation circuit comprises:
a floating-point matrix operation circuit coupled to the memory to obtain the activation matrix and the scaled weight matrix, wherein the floating-point matrix operation circuit performs the floating-point matrix operation on the activation matrix and the scaled weight matrix to obtain the first operation result matrix; and
a floating-point-to-integer conversion circuit coupled to the floating-point matrix operation circuit to receive the first operation result matrix, wherein the floating-point-to-integer conversion circuit performs the floating-point-to-integer conversion to convert the first operation result matrix into the second operation result matrix, and the floating-point-to-integer conversion circuit stores the second operation result matrix in the memory.

10. A numerical conversion method in neural network calculation, the method comprising:
performing integer-to-floating-point conversion to convert a first activation matrix into a second activation matrix; and
performing a floating-point matrix operation on the second activation matrix and a scaled weight matrix to obtain an operation result matrix, wherein the scaled weight matrix is a scaled result generated by performing pre-scaling on an original weight matrix of a trained neural network model.

11. The numerical conversion method according to claim 10, wherein the pre-scaling comprises:
multiplying the original weight matrix by a scaling factor to obtain the scaled weight matrix; or
dividing the original weight matrix by the scaling factor to obtain the scaled weight matrix.

12. The numerical conversion method according to claim 10, wherein the floating-point matrix operation comprises a matrix multiplication-addition operation, and the matrix multiplication-addition operation comprises:
performing a matrix multiplication operation on the second activation matrix and the scaled weight matrix to obtain a multiplication result matrix; and
performing a matrix addition operation on the multiplication result matrix and a bias matrix to obtain the operation result matrix.

13. A neural network calculation device comprising:
a memory configured to store and provide a scaled weight matrix, wherein the scaled weight matrix is a scaled result generated by performing pre-scaling on an original weight matrix of a trained neural network model; and
a matrix operation circuit coupled to the memory, wherein the matrix operation circuit performs integer-to-floating-point conversion to convert a first activation matrix into a second activation matrix, and the matrix operation circuit performs a floating-point matrix operation on the second activation matrix and the scaled weight matrix to obtain an operation result matrix.

14. The neural network calculation device according to claim 13, wherein the pre-scaling comprises:
multiplying the original weight matrix by a scaling factor to obtain the scaled weight matrix by a host device, or dividing the original weight matrix by the scaling factor to obtain the scaled weight matrix by the host device; and
storing the scaled weight matrix by the host device in the memory for use by the matrix operation circuit.

15. The neural network calculation device according to claim 13, wherein the floating-point matrix operation comprises a matrix multiplication-addition operation, and the matrix multiplication-addition operation comprises:
performing a matrix multiplication operation on the second activation matrix and the scaled weight matrix to obtain a multiplication result matrix by the matrix operation circuit; and
performing a matrix addition operation on the multiplication result matrix and a bias matrix to obtain the operation result matrix by the matrix operation circuit.

16. The neural network calculation device according to claim 13, wherein the matrix operation circuit comprises:
an integer-to-floating-point conversion circuit coupled to the memory to obtain the first activation matrix, wherein the integer-to-floating-point conversion circuit performs the integer-to-floating-point conversion to convert the first activation matrix into the second activation matrix; and
a floating-point matrix operation circuit coupled to the memory to obtain the scaled weight matrix, and coupled to the integer-to-floating-point conversion circuit to receive the second activation matrix, wherein the floating-point matrix operation circuit performs the floating-point matrix operation on the second activation matrix and the scaled weight matrix to obtain the operation result matrix, and the floating-point matrix operation circuit stores the operation result matrix in the memory.
